(19) United States
(12) Patent Application Publication
(10) Pub. No.: US 2006/0021485 A1
(43) Pub. Date: Feb. 2, 2006

(54) Gift wrap cutting system

(76) Inventor: John D. Richards, Palm Harbor, FL (US)

Correspondence Address: DAVID KIEWIT, 5901 THIRD ST SOUTH, ST PETERSBURG, FL, 33705, US

(21) Appl. No.: 11/122,316

(22) Filed: May 4, 2005

Related U.S. Application Data
(60) Provisional application No. 60/568,351, filed on May 5, 2004.

(51) Int. Cl. B26D 1/03

(52) U.S. Cl. 83/425.4; 83/614; 83/649

(57) ABSTRACT

A gift wrap storage and cutting system comprises a box for storing rolls of paper; and at least one cutter arranged to slide along a slide block guide parallel to an edge of the box. Each cutter comprises a blade, a blade guard, a paper guide, and a slide block that engages the slide block guide. The blade guard is spaced apart from the slide block by less than a width of a user's finger. Measurement graduation lines can be provided on the front of the container to aid in setting cutter positions.

### BACKGROUND OF THE INVENTION

### FIELD OF THE INVENTION

The present application claims the priority of my U.S. provisional application 60/568351, filed on May 5, 2004. The invention relates generally to wrapping material cutting & storage and more specifically to a gift wrap storage and cutting system for storage of rolls of gift wrap material, measurement of objects to be wrapped, and cutting wrapping material to the required size to wrap objects.

### BACKGROUND INFORMATION

It can be appreciated that wrapping material cutting & storage have been in use for years. Typically, wrapping material cutting systems are comprised of devices for holding, dispensing, and cutting paper or wrapping material from a roll of some material. Some of these products use a traveling cutter to sever the material from the roll. U.S. Pat. No. 4,787,284 to Chen shows a cutting apparatus for household plastic wrap film consisting of a cutter mounted with a safety razor. The wrap film is cut to the desired length after it is pulled from the roll. This apparatus does not allow the user to cut the wrap film to a width less than the width of the material on the roll. The cutter in this apparatus is suitable for cutting household plastic wrap. It is poorly suited for cutting a more substantial material such as paper; when attempted the cutter will sever the paper from the roll leaving ragged edges on both sides of the cut. When the cutter is stationary and the user attempts to cut a sheet of gift wrap by pulling the sheet through the cutter the gift wrap tears before a cut is initiated. There also exist products which can cut rolled material into strips of predetermined width. There also exist products suitable for the storage of multiple rolls of gift wrap and gift wrap accessories such as tape, ribbon, tags, etc.

Another problem with conventional wrapping material cutting systems is that they do not feature a simple effective cutter for initiating the cut in paper wrapping material and for cleanly cutting paper wrapping material to the width required as the material is pulled from the roll.

While these devices may be suitable for the particular purpose to which they address, they are not suitable for the combined functions of storage of rolls of gift wrap material and measurement of objects to be wrapped and cutting wrapping material to the required size to wrap objects. The main problem with conventional wrap material cutting systems & storage systems is that no single product combines the functions of: storage of rolls; measurement of the object to be wrapped; and cutting wrapping material to the width and length required for wrapping the object. Another problem with conventional wrapping material cutting systems is that they do not feature a simple effective cutter for initiating a cut in paper wrapping material and for cleanly cutting paper wrapping material to the width required as the material is pulled from the roll.

In these respects, the gift wrap storage and cutting system according to the present invention substantially departs from the conventional concepts and designs of the prior art, and in so doing provides an apparatus primarily developed for the purpose of storage of rolls of gift wrap material, measurement of objects to be wrapped, and cutting wrapping material to required size to wrap objects.

### BRIEF SUMMARY OF THE INVENTION

The general purpose of the present invention, which will be described subsequently in greater detail, is to provide a new gift wrap cutting system that has many of the advantages of the wrap material cutting systems & storage systems mentioned heretofore and many novel features that result in a new gift wrap cutting system which is not anticipated, rendered obvious, suggested, or even implied by any of the prior art, either alone or in any combination thereof.

To attain this, the present invention preferably comprises a container; a compartment divider; one or more slide block guide components; at least one cutter ; edge guides; and measurement graduation lines. The container preferably consists of a box 14 with a latching cover 15 attached with a hinge 25 as shown in FIG. 1. The compartment divider 30 is preferably provided to separate the box into two compartments, as shown in FIG. 1. The larger compartment is sized to accommodate rolls of wrapping material and the smaller one can be used to store tape and other wrapping aids.

In one embodiment the slide block guide system comprises a slide block support 35 and slide block guide rods 45 and 47 as shown in FIG. 1. In other embodiments the slide block guide function may be provided by a specially shaped portion of the box. Each preferred cutter 50, as shown in FIG. 2, comprises a blade 55, a blade guard 60, a flexible paper guide 65, and a slide block 52 arranged as shown in FIGS. 4 and 5. The left and right edge guides 75, 80, as shown in FIG. 2, are slide blocks which travel on slide block guide rod 45. The edge guides are used to guide the paper 100 as it is pulled off the roll 105, as shown in FIG. 9. In addition, measurement graduation lines 90 are preferably provided on the front of the box 14 as shown on FIG. 8.

Although it is believed that the foregoing rather broad summary description may be of use to one who is skilled in the art and who wishes to learn how to practice the invention, it will be recognized that the foregoing recital is not intended to list all of the features and advantages. Those skilled in the art will appreciate that they may readily use both the underlying ideas and the specific embodiments disclosed in the following Detailed Description as a basis for designing other arrangements for carrying out the same purposes of the present invention and that such equivalent constructions are within the spirit and scope of the invention in its broadest form. Moreover, it may be noted that different embodiments of the invention may provide various combinations of the recited features and advantages of the invention, and that less than all of the recited features and advantages may be provided by some embodiments.

### BRIEF DESCRIPTION OF THE SEVERAL VIEWS OF THE DRAWING

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of a box portion of the invention.

FIG. 2 is a perspective view showing cutters and edge guides attached to the box.

FIG. 3 is a plan view of a flexible paper guide.

FIG. 4 is a side view of an embodiment of a cutter.

FIG. 5 is a front view of the cutter of FIG. 4.

FIG. 6 is a detail side view of a cutter 50 showing a sheet of paper entering the cutter.

FIG. 7 is the detail side view of FIG. 6 showing the paper being cut.

FIG. 8 is a perspective view showing an arrangement for determining the location of cuts for cutting paper to fit a package.

FIG. 9 is a plan view of apparatus of the invention showing paper being fed from a roll and cut to width.

FIG. 10 is a plan view of apparatus of the invention showing paper with width and cutoff cuts initiated.

FIG. 11a is a cross-sectional view of an alternate embodiment of a cutter and slide block guide arrangement where a blade is set perpendicular to the guide.

FIG. 11b is another cross-sectional view of the embodiment of FIG. 11a where the blade is set parallel to the slide block guide.

### DETAILED DESCRIPTION OF THE INVENTION

In studying this Detailed Description, the reader may be aided by noting definitions of certain words and phrases used throughout this patent document. Wherever those definitions are provided, those of ordinary skill in the art should understand that in many, if not most instances, such definitions apply to both preceding and following uses of such defined words and phrases. At the outset of this Description, one may note that the terms “include” and “comprise,” as well as derivatives thereof, mean inclusion without limitation; the term “or,” is inclusive, meaning and/or; “slide block guide” stands for any sort of straight track, rail or other linear guide means, and ‘slide block’ stands for a portion of a cutter device designed to engage the slide block guide.

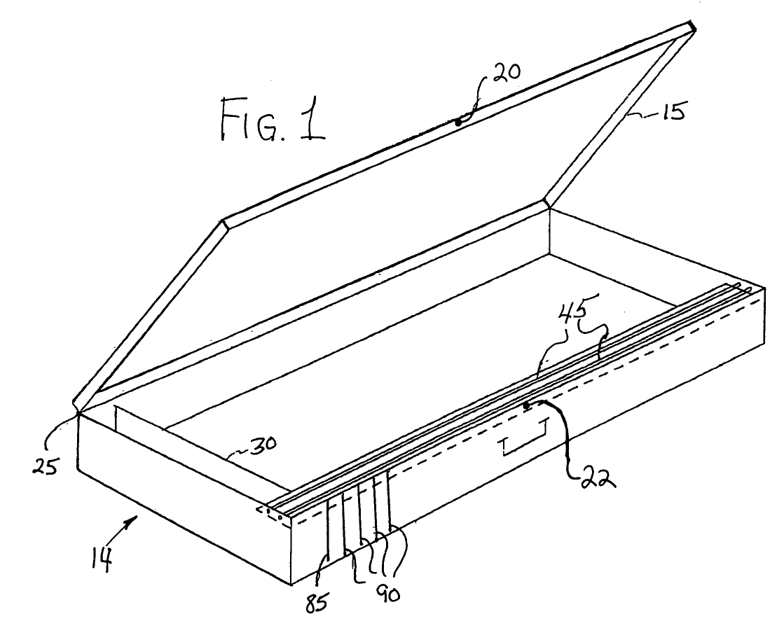

A preferred embodiment of the invention comprises a container having one or more cutter guide portions, although it will be recognized from the ensuing discussion that the guide elements may be independent of any container, spindle or other means for storing paper. A preferred container comprises a box 14 and a cover 15 attached to the box 14 with a hinge 25 as shown in FIG. 1. A latch 20, 22 may be used to secure the cover for transport and/or storage. A carry handle 40 may be provided on the front face of 14 for ease of handling during transport. Different materials may be used to construct the box, cover, hinge, and latch. The dimensions of the container may be varied to accommodate different sizes of paper rolls and to provide storage for various numbers of such rolls.

A compartment divider 30 may be used to separate the box 14 into two compartments as shown in FIG. 1. In these cases the larger compartment is sized to accommodate rolls of wrapping material arrayed so that a respective axis of each of the rolls is parallel and aligned with an edge of the box. The smaller compartment may be used to store wrapping accessories. Different materials may be used to construct the compartment divider 30. The dimensions of the compartment divider may be varied to accommodate different container sizes.

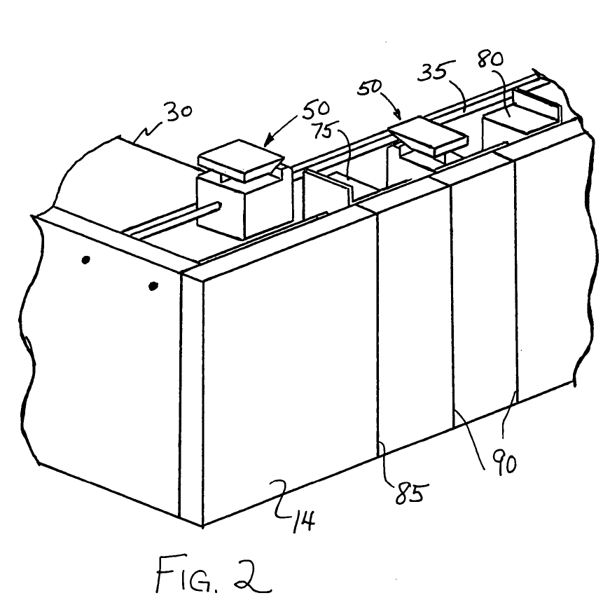

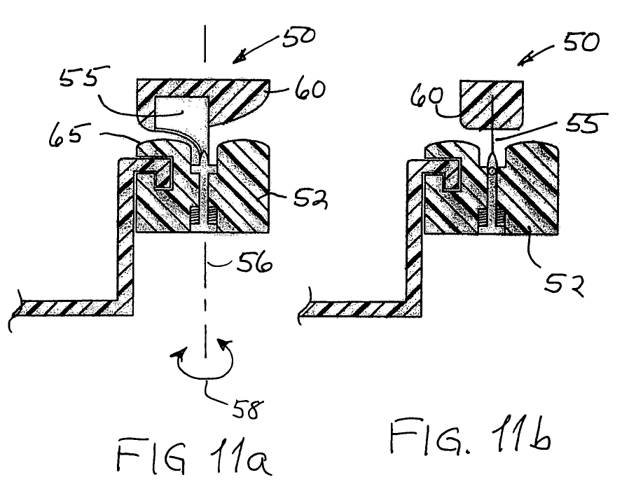

In one embodiment of the invention a slide block guide arrangement comprises a slide block support 35 and slide block guides 45 as shown in FIG. 1. This slide block support 35 supports the cutter(s) 50 and edge guides 75, 80 as they are moved along the slide block guides 45, to maintain correct positioning in relation to the top of the open box 14. The circular section guide rods depicted in FIG. 2 may be replaced by rods of different cross sectional shapes, by wires, by rails, by channels, or any other structure which, in conjunction with the design of the slide block, restricts the movement of the slide block to one dimension. In a particular preferred embodiment depicted in FIGS. 11a and 11b, a single slide block guide rail is integrally formed with a wall of the box 14 and slidably engages a slide block 52 by suitable means, such as the keyed slot 54. It will be appreciated from the disclosure provided hereinafter that although FIGS. 11a and 11b show only one keyed slot on one side of a block, one could equally well provide keyed slots on two sides of the block, or could provide two perpendicular keyed slots or grooves in the bottom of the slide block. Moreover, one could configure an equivalent cutter in which a tenon extending outwardly from the slide block portion engages a linear slot acting as the slide block guide.

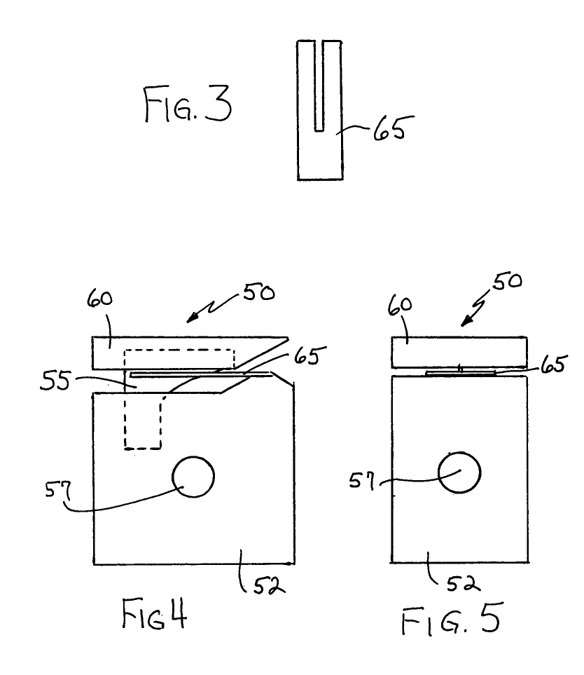

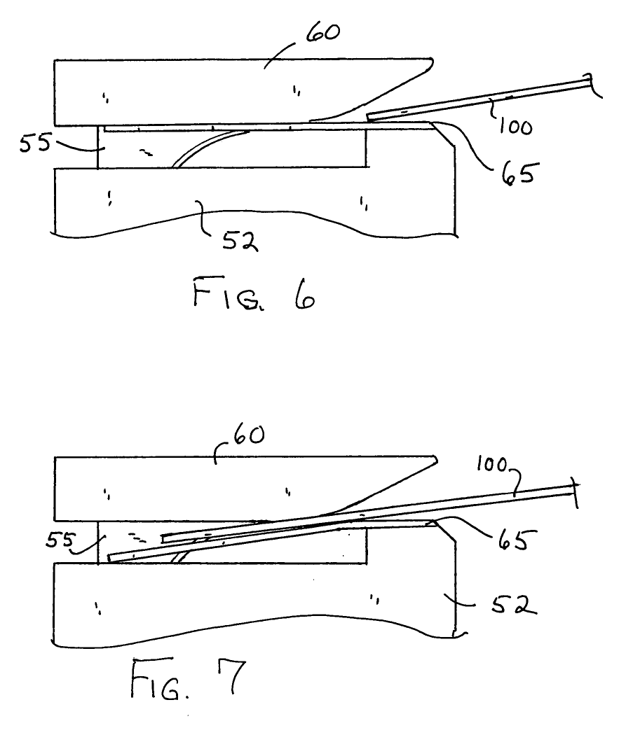

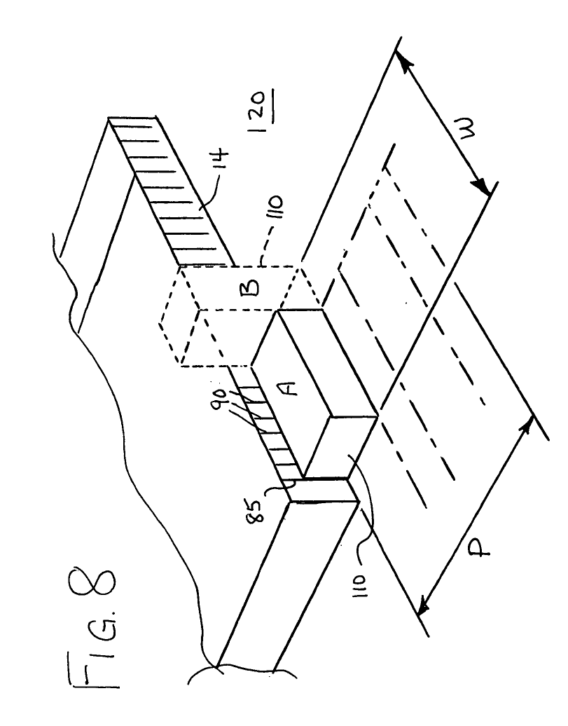

Each preferred cutter 50 comprises a blade 55, a blade guard 60, a paper guide 65, and a slide block 52. In the embodiment depicted in FIGS. 4 and 5 the slide block guide slidably engages the slide block 52 through a selected one of two throughholes, depending on whether the cutter is used as the width cutter or the cutoff cutter. In this embodiment one cutter, used for cutting a selected width of the paper web, travels along a slide block guide 45 with the plane of the blade perpendicular to the axis of the slide block guide. A second cutter, used to cut paper off the roll, travels along another slide block guide with the plane of its blade parallel to the axis of the slide block guide rod. In other embodiments the apparatus comprises a single cutter 50 having a blade 55 that can be turned through ninety degrees of arc about a vertical axis 56, as indicated by the double-headed arrow 58 in FIG. 11a. In yet other embodiments, the apparatus comprises a single cutter having two perpendicular slots 54 in a slide block portion, thus allowing a user to remove the cutter from the guide after a first cut, re-attach the cutter to the guide by means of the slot that was not used during the first cut, and to then make a second cut.

The blade guard 60 is spaced apart from the slide block 52 by a distance adequate to allow paper to pass between the guard 60 and the block 52 but that is nonetheless much smaller than the thickness of a user's finger. This provides a measure of operator safety not found in many other paper cutting arrangements.

In embodiments in which the blade does not turn with respect to the slide block 52, a preferred paper guide 65 comprises a thin bifurcated sheet of a flexible material fixedly attached to the slide block so that the bifurcated end portions of the paper guide are disposed about the blade. In cutter embodiments in which the blade is rotatable, the paper guide may comprise a raised toroidal portion of the upper surface of the slide block, as depicted in FIGS. 11a, 11b. In either arrangement, a preferred vertical setting for the paper guide 65 is slightly higher than the top of the wall of the box 14 so that the paper can be easily pulled through the cutter 50 and over the wall of the box. Other alternatives to the flexible paper guide as shown in FIG. 4 is to replace it with a piece of compressible material fastened to the top of the slide block.

The cutting edge of the preferred blade is shaped as a spiral curve having an infinite radius at the point of tangency with the bottom of the blade guard. The paper guide 65 is thus positioned to hold the paper against the bottom of the blade guard as the paper is pulled into the cutter. The decrease in the radius of the blade cutting edge causes the blade to slice the paper to initiate the cut as the paper is pulled through the cutter 50. The paper guide 65 allows initiation of the cut without binding or tearing the paper.

Different materials may be used to construct the cutter components. The dimensions of the cutter components may be varied, including the geometry of the cutting edge of the blade. Alternates for the blade as shown in FIG. 4 may be to use a fine wire, wheel, or saw blade to cut the paper. The invention may be used for any other wrapping materials, for example plastic or cloth.

In preferred embodiments, the left and right edge guides 75, 80 may be slide blocks which travel on a slide block guide 45 and may be used to guide the paper 100 as it is pulled off the roll 105. The edge guides are preferably arranged as shown in FIG. 2, with one on each side of the width cutter 50. Different materials may be used to construct the edge guides. The dimensions of the edge guides may be varied.

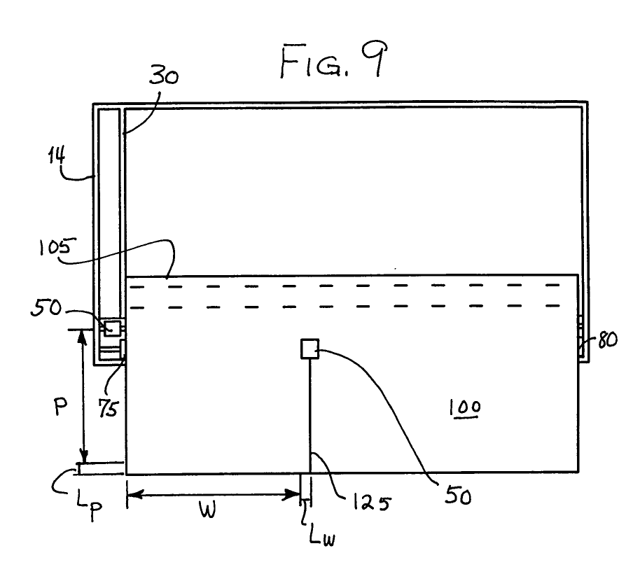

Measurement graduation lines 90 are preferably provided on the front of the box 14 as shown on FIG. 8. In a particular preferred arrangement, the leftmost line aligns with the right edge of the compartment divider 30 and the left end of the roll 105. Different materials and/or techniques may be used to construct the measurement graduation lines. The dimensions of the measurement graduation lines may be varied.

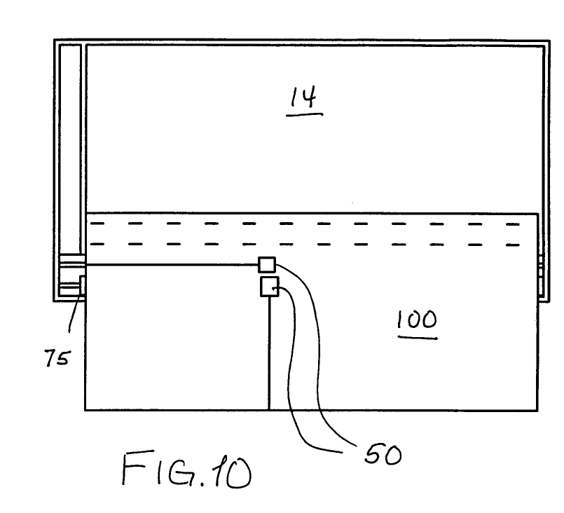

An exemplar method of use of apparatus of the invention to wrap a container 110 is illustrated in FIGS. 8-10, in which an embodiment of the apparatus having separate width and cutoff cutters is used for clarity of presentation. At the beginning of the process, one lays the container 110 on a relatively flat surface 120 adjacent the box 14 Wrap material 100 is then unrolled from a roll 105 having one end abutting the compartment divider so that that end of the roll is aligned with the baseline 85 of the gradation lines 90. The left edge guide 75 is moved into alignment with the left end of the roll (and the baseline 85 as shown in FIG. 8) and the right edge guide 80 is aligned with the right end of the roll. In embodiments having two cutters, the cutoff cutter is moved to a non-interfering position adjacent one end of the guide.

The object to be wrapped 110 is then placed in an initial Position A against the front wall of the box 14 so as to align the left end of the object 110 with the zero point 85. The object 110 is then rotated by ninety degrees into Position B. A cutter 50 is then moved so that the plane of the blade 55 is the same as the plane of the rightmost end of the object 110. The distance from the baseline 85 to the plane of the blade 55 is now one half of the girth of the object 110 as measured parallel to the front wall of the box 14 and denoted by the double-headed arrow W in FIG. 8. The cutter 50 is then slid to the right an additional distance, denoted as Lw, that is equal to twice the amount of paper overlap desired. The object 110 is then returned to Position A and rotated away from the front wall of the box 14 three times by ninety degrees each time. At this point the distance from the front wall of the box 14 to the most distant face of the object 110 is equal to the girth of the object 110 perpendicular to the front wall of 14, denoted by the double headed arrow labeled P. This is the minimum length required to cover the object. The object 110 is then moved away from the box 14 by an additional distance, denoted as Lp , equal to the overlap desired. The leading edge of the paper 100 is pulled from the roll 105 through the cutter 50, creating a cut 125 until the leading edge of 100 is aligned with the most distant face of the object 110.

The cutoff cut is then made by sliding the cutoff cutter through the paper 100 until the length of the cut equals the desired width of the wrap piece.

To set up for cutting a second wrap piece from the remaining section of the paper 100, the left edge guide 75 is moved to be aligned with the new left edge created by the cut 125, the paper is rolled back onto the roll 105, and the steps of the operation are repeated using the new position of the left edge guide 75 as the baseline for measurement of the next object to be wrapped.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Although the present invention has been described with respect to several preferred embodiments, many modifications and alterations can be made without departing from the invention. Accordingly, it is intended that all such modifications and alterations be considered as within the spirit and scope of the invention as defined in the attached claims.

1) An apparatus for storing and cutting paper supplied on rolls, the apparatus comprising:
a box for storing a plurality of the rolls of paper arranged so that a respective axis of each roll is parallel to a selected edge of the box;
at least one slide block guide affixed parallel to the selected edge of the box; and
at least one cutter comprising:
a respective slide block portion engaging a respective slide block guide for sliding motion therealong;
a respective blade guard portion spaced apart from the respective slide block portion by a selected width that is less than a width of a user's finger; and
a respective knife blade fixedly attached to the respective blade guard and connecting the respective blade guard to the respective slide block portion.

2) The apparatus of claim 1 wherein the at least one cutter comprises a single cutter in which the knife blade is rotatably connected to the slide block portion so that the knife blade and blade guard portions are rotatable from a first setting in which the knife blade is parallel to the selected edge of the box and a second setting in which the knife blade is perpendicular thereto.

3) The apparatus of claim 2 wherein the at least one slide block guide comprises a single slide block guide comprising a portion of the selected edge of the box.

4) The apparatus of claim 1 comprising two slide block guides, each associated with a respective cutter, wherein the respective knife blade of one of the cutters is aligned perpendicular to the selected edge of the box and the respective knife blade of the second of the cutters is aligned parallel to the selected edge of the box.

5) The apparatus of claim 4 wherein each cutter further comprises a respective flexible paper guide having a respective first end fixedly attached to the respective slide block portion, each paper guide further having a respective bifurcated second end disposed about the respective knife blade.

6) The apparatus of claim 1 comprising a single cutter that selectively engages a single slide block guide in one of two mutually perpendicular settings such that the single knife blade is parallel to the selected edge in a first of the two settings and the single knife blade is perpendicular to the selected edge in the second of the two settings.

7) The apparatus of claim 6 wherein the single slide block portion comprises two mutually perpendicular keyed slots, each of the keyed slots engaging the slide block guide in a respective one of the settings.

8) The apparatus of claim 6 wherein the single slide block guide comprises a portion of the selected edge of the box.

9) The apparatus of claim 6 wherein the cutter further comprises a flexible paper guide having a first end fixedly attached to the slide block portion, the paper guide further having a bifurcated second end disposed about the knife blade.

10) An apparatus for storing and cutting paper supplied on rolls, the apparatus comprising:
a box for storing a plurality of the rolls of paper arranged so that a respective axis of each roll is parallel to a selected edge of the box;
two slide block guides affixed parallel to the selected edge of the box; and
two cutters, each cutter comprising:
a respective slide block portion engaging a respective slide block guide for sliding motion therealong;
a respective blade guard portion spaced apart from the respective slide block portion by a selected width that is less than a width of a user's finger; and
a respective knife blade fixedly attached to the respective blade guard and connecting the respective blade guard to the respective slide block portion, wherein the respective knife blade of one of the cutters is aligned perpendicular to the selected edge of the box and the respective knife blade of the second of the cutters is aligned parallel to the selected edge of the box.

11) The apparatus of claim 10 wherein each cutter further comprises a respective flexible paper guide having a respective first end fixedly attached to the respective slide block portion, each paper guide further having a respective bifurcated second end disposed about the respective knife blade.

12) An apparatus for storing and cutting paper supplied on rolls, the apparatus comprising:
a box for storing a plurality of the rolls of paper arranged so that a respective axis of each roll is parallel to a selected edge of the box;
a slide block guide affixed parallel to the selected edge of the box; and
a cutter comprising:
a slide block portion engaging the slide block guide for sliding motion therealong;
a blade guard portion spaced apart from the slide block portion by a selected width that is less than a width of a user's finger; and
a knife blade fixedly attached to the blade guard and connecting the blade guard to the respective slide block portion, the knife blade selectively settable in either a first setting in which the blade is parallel to the selected edge of the box and a second setting in which the blade is perpendicular thereto.

13) The apparatus of claim 12 wherein the slide block guide comprises a portion of the selected edge of the box.

14) The apparatus of claim 12 wherein the knife blade is rotatably connected to the slide block portion so that the knife blade and blade guard portions are rotatable between the first and second setting.

15) The apparatus of claim 12 wherein the cutter selectively engages the slide block guide to set the knife blade in a selected one of the two settings.

16) The apparatus of claim 15 wherein the slide block portion comprises two mutually perpendicular keyed slots, each of the keyed slots for selectively engaging the slide block guide in a respective one of the settings.

17) The apparatus of claim 15 wherein the slide block guide comprises a portion of the selected edge of the box.

18) The apparatus of claim 15 wherein the cutter further comprises a flexible paper guide having a first end fixedly attached to the slide block portion, the paper guide further having a bifurcated second end disposed about the knife blade.
